(19) United States
(12) Patent Application Publication
(10) Pub. No.: US 2026/0280470 A1
(43) Pub. Date: Sep. 17, 2026

(54) MOUNTING SYSTEM FOR SOLAR MODULES

(71) Applicant: World4Solar Inc., Reno, NV (US)

(72) Inventors: Mario Hufnagl, Oberndorf bei Salzburg (AT); Marc Hofer, Göming (AT)

(21) Appl. No.: 19/469,747

(22) PCT Filed: Feb. 29, 2024
(86) PCT No.: PCT/AT2024/060075

§ 371 Date: Sep. 26, 2025

(30) Foreign Application Priority Data
Mar. 28, 2023 (AT) A 60053/2023
Aug. 29, 2023 (AT) A 50684/2023

(51) Int. Cl. H02S 20/20; F24S 25/00; F24S 25/636; F24S 80/70

(52) U.S. Cl. CPC H02S 20/20; F24S 25/636; F24S 80/70; F24S 2025/804

(57) ABSTRACT

The invention relates to a mounting system for solar modules (1200, 1200A, 1200B), having a support structure (2000) with at least two longitudinal beams (220, 220A, 220B, 221) and at least one transverse beam (200, 201), wherein the at least one transverse beam (200, 201) is arranged substantially transversely to the longitudinal beams (220, 220A, 220B, 221), and wherein at least one clamping strip (230, 230A, 230B) is associated with each longitudinal beam (220, 220A, 220B, 221), wherein the at least one clamping strip (230, 230A, 230B) has a clamping lug (233) which can be inserted into a receptacle (224) of a longitudinal beam (220, 220A, 220B, 221), and wherein the at least one clamping strip (230, 230A, 230B) can be moved from a mounting position, in which the clamping lug (233) is only partially accommodated in the receptacle (224), into a clamping position, into a clamping position in which the clamping lug (233) is completely accommodated in the receptacle and is fixed in the clamping position, and to a method for mounting solar modules (1200, 1200A, 1200B).

The invention relates to a mounting system for solar modules, having a support structure with at least two longitudinal beams and at least one transverse beam, wherein the at least one transverse beam is arranged substantially transversely to the longitudinal beams, and wherein at least one clamping strip is associated with each longitudinal beam.

The generation of energy using sunlight plays a prominent role in the transition from fossil fuels to renewable energy sources. In particular, the installation of photovoltaic systems with photovoltaic panels on roofs, but also on other building structures such as carports or patio covers, for example, is being promoted with government funding.

In particular, support structures are required for the installation of such systems, in which the respective solar modules are mounted, wherein these support structures should also protect the solar modules securely against environmental influences, in particular against wind and rain, but without impairing the efficiency of these solar modules, for example through shading.

WO 2010/123929 A1 describes a carport with a photovoltaic system in which the solar modules are fixed in a support structure with the aid of clamping strips, wherein the clamping strips are screwed to the support structure with the aid of clamping blocks.

In US 2019/0372515 A1, a mounting system for photovoltaic panels of the type as mentioned above has become known, wherein longitudinal beams are provided which have an undercut U-profile into which a cover strip projects, which has an I-shaped cross-section. This cover strip is brought into a clamping position, in which the photovoltaic panels are fixed in the mounting system, by means of a tension element which interacts with the longitudinal beam.

A disadvantage of the known prior art is that a large number of individual parts are required to assemble the photovoltaic panels, which has a considerable negative impact on the mounting time required.

It is therefore the object of the invention to provide a mounting system that allows solar modules to be mounted quickly and safely.

According to the invention, this object is solved by a mounting system of the type as mentioned above in that the at least one clamping strip has a clamping lug which can be inserted into a receptacle of the longitudinal beam, wherein the at least one clamping strip can be moved from a mounting position, in which the clamping lug is only partially accommodated in the receptacle, into a clamping position in which the clamping lug is completely accommodated in the receptacle and fixed in the clamping position.

In the mounting position, in which the clamping strip is connected to the longitudinal beam via the clamping lug, the solar modules can be inserted between the clamping strips and the longitudinal strips and do not need to be additionally secured against slipping before the clamping strip is transferred to the clamping position in which the solar module is fixed in position.

Preferably, it is provided in this case that the at least one transverse beam has a U-profile and the at least two longitudinal beams and the clamping strips each have a T-shaped cross-section. The at least one transverse beam is used to hold the two longitudinal beams, while the clamping strip is only in contact with the respective longitudinal beam. The inserted solar modules also only rest on the longitudinal beams and are fixed in their end position by means of a clamping strip. By arranging the solar modules in the support structure in this way, stresses caused by thermal expansion of the various materials can be avoided, thus optimizing the service life of the solar modules.

In the context of this disclosure, “solar module” is understood to mean both a photovoltaic panel and a solar thermal module.

In a particularly preferred embodiment of the invention, it is provided that at least one longitudinal seal is arranged on the at least one clamping strip and on the at least one longitudinal beam in each case. This longitudinal seal protects the surface of the solar modules when they are inserted into the support structure according to the invention and also serves to seal against moisture.

If more than one solar module is provided, it is particularly advantageous if at least one transverse seal is arranged on the edges of at least two solar modules facing each other, which are arranged between at least two longitudinal beams, which is compressed in a liquid-tight manner in the clamping position of the clamping rail. The combination of longitudinal seals and transverse seals in particular results in a liquid-tight surface that serves as a water-bearing roof, especially in a carport.

It is particularly preferably provided in this case that the at least one longitudinal seal and/or the at least one transverse seal is made of a closed-pore, elastic foam material. This foam is made of rubber (“sponge rubber”) or EPDM (“neoprene”), for example.

In order to ensure rapid mounting, a positioning tool and a fixing tool are provided in particular for moving the at least one clamping strip from the mounting position into the clamping position, which are removed again after the clamping strips have been fixed in the clamping position.

The mounting system according to the invention has proven to be particularly suitable for use in the production of a roof surface of a carport with solar modules, preferably with photovoltaic panels, or for the production of a photovoltaic system on a roof surface of a building or a building structure.

The object is further solved with a method according to the invention for mounting solar modules in a support structure with at least two longitudinal beams and at least one transverse beam, wherein the at least one transverse beam is arranged substantially transversely to the longitudinal beams, and wherein at least one clamping strip is associated with each longitudinal beam. In this case, the at least one clamping strip has a clamping lug which is inserted into a receptacle of a longitudinal beam, wherein the at least one clamping strip is first brought into a mounting position in which the clamping lug is only partially accommodated in the receptacle, then at least one solar module is inserted between at least two longitudinal beams and the clamping strips associated with them, and finally the clamping strips are brought into a clamping position in which the clamping lug is completely accommodated in the receptacle and fixed in this clamping position.

Preferably, it is provided in this case that a transverse seal is arranged on the touching edges of the at least two solar modules, wherein this transverse seal is either arranged loosely between the solar cells or is attached non-detachably, for example by gluing, to at least one edge of a solar module.

In the following, the invention is explained in more detail by means of a non-limiting exemplary embodiment with associated figures, wherein:

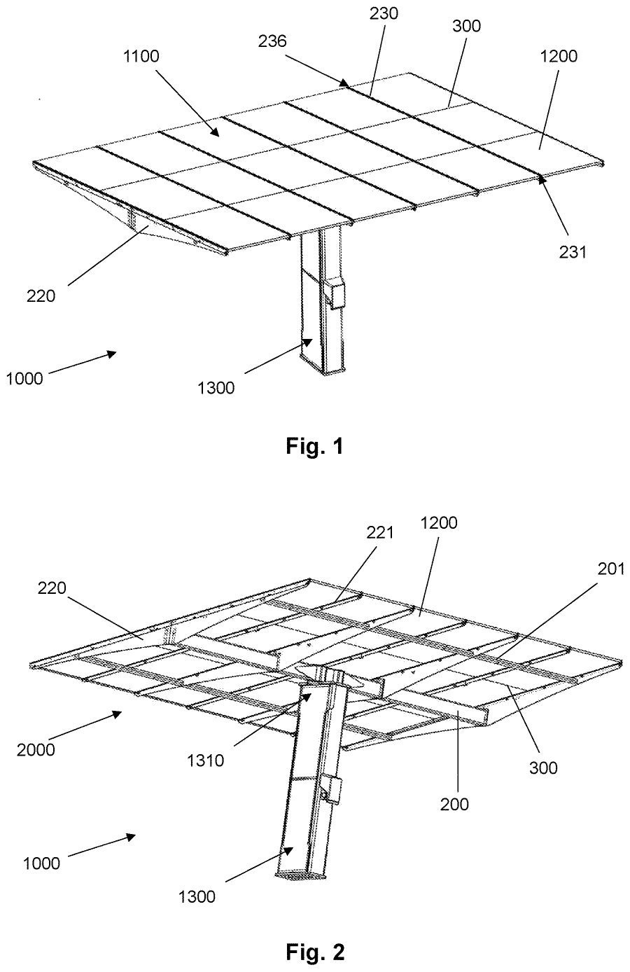

FIG. 1 shows a first perspective view of a carport from above;

FIG. 2 shows the carport from FIG. 1 without clamping strips and photovoltaic panels;

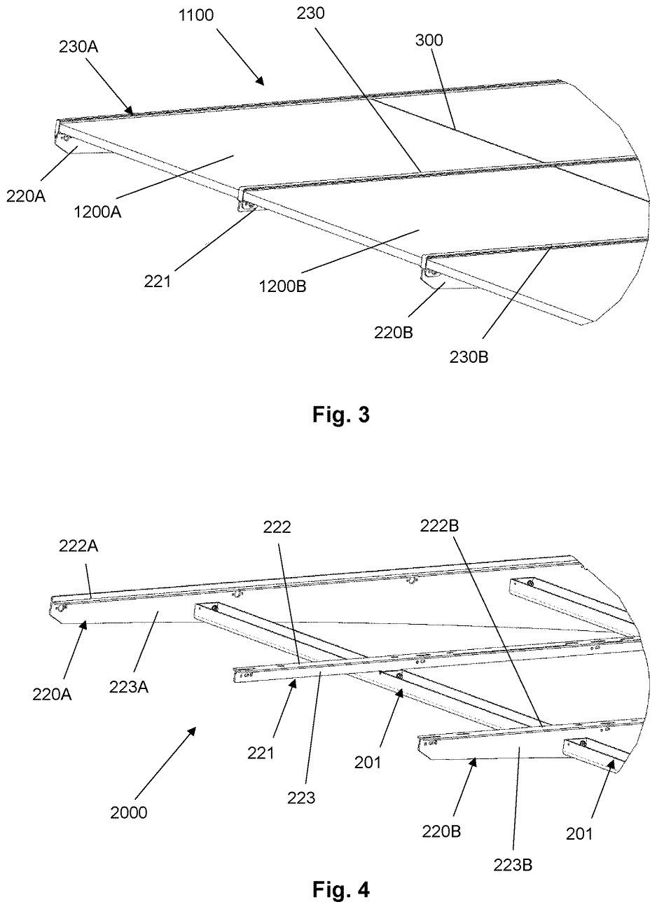

FIG. 3 shows a detailed view from FIG. 1;

FIG. 4 shows a detailed view of the support structure from FIG. 2;

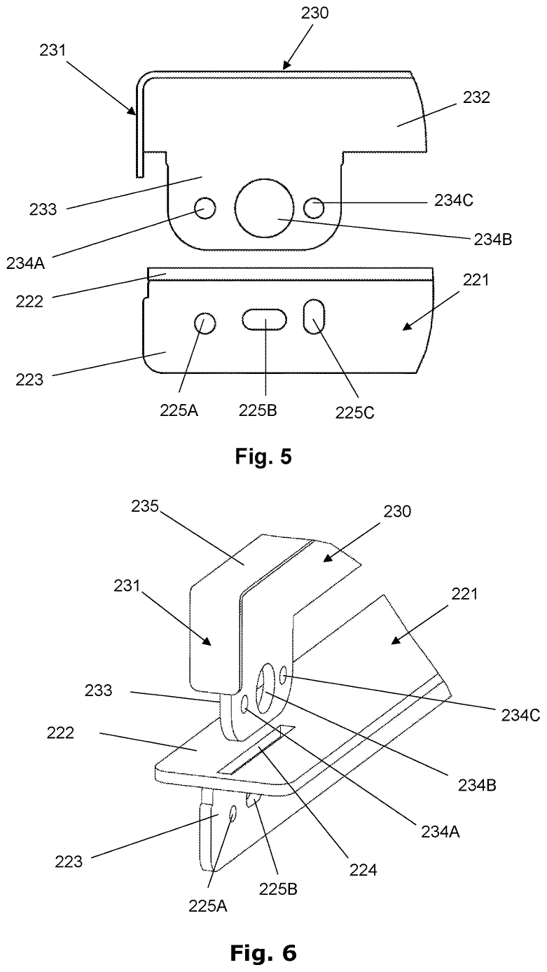

FIG. 5 shows a detailed view of a longitudinal beam and a terminal strip associated with it;

FIG. 6 shows a detailed perspective view of the longitudinal beam and the terminal strip from FIG. 5;

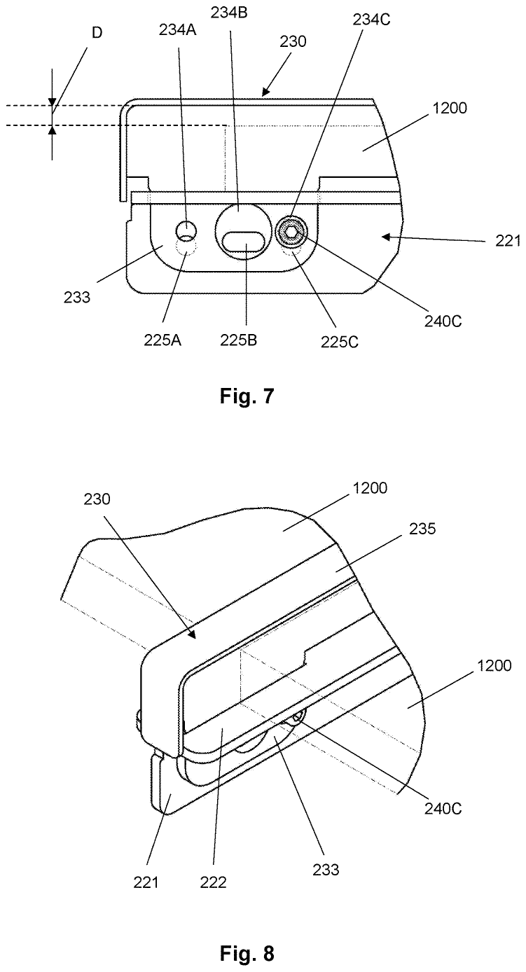

FIG. 7 shows a side view of the longitudinal beam and the clamping strip from FIG. 5 in the mounting position;

FIG. 8 shows a detailed perspective view of the longitudinal beam and the terminal strip from FIG. 7;

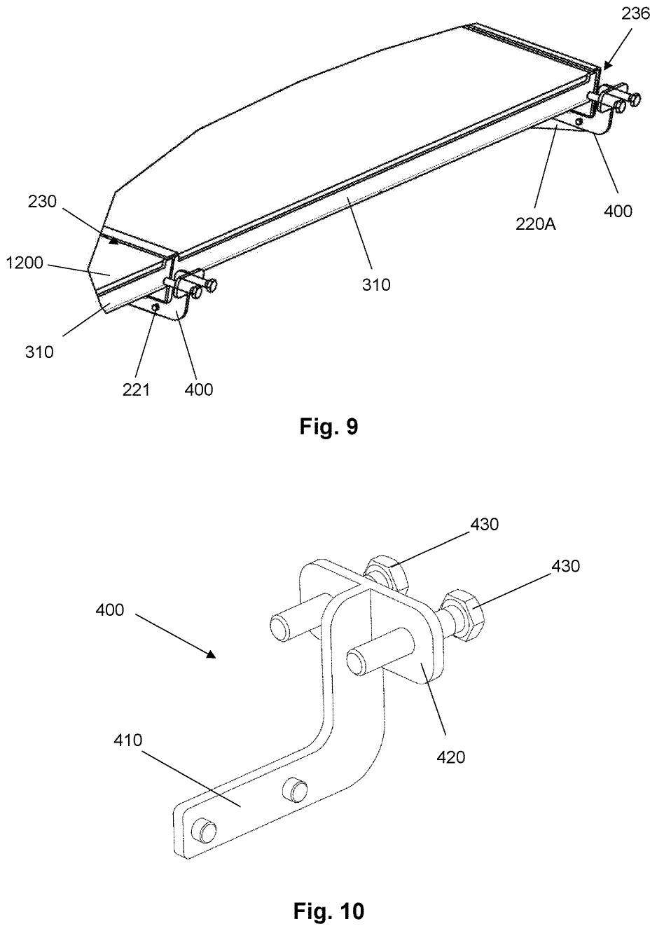

FIG. 9 shows a detailed perspective view of the distal end of the longitudinal beam and the clamping strip with inserted photovoltaic panels;

FIG. 10 shows a perspective view of the positioning tool;

FIG. 11 shows a perspective view of the fixing tool;

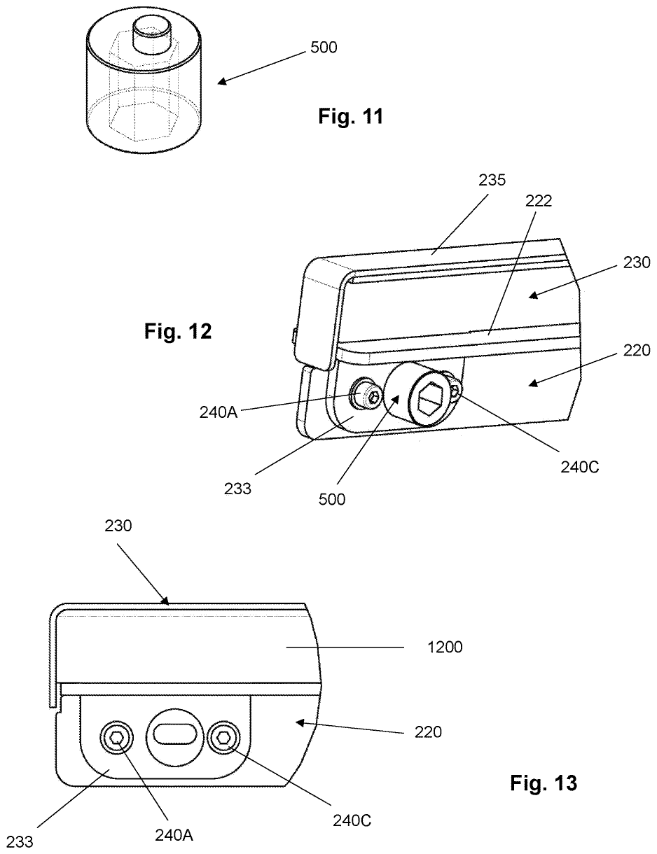

FIG. 12 shows a detailed perspective view of the longitudinal beam and the clamping strip in the clamping position; and

FIG. 13 shows a side view of the longitudinal beam and the clamping strip from FIG. 12.

In FIG. 1, a carport 1000 is shown in a first perspective view from above, the roof surface 1100 of which in the present exemplary embodiment has eighteen photovoltaic panels 1200 in three rows and can be fastened to a substrate via a support column 1300. The roof surface 1100 has a support structure 2000, which can be seen in particular in FIG. 2, a further perspective view from below.

This support structure 2000 has a main transverse beam 200 and two transverse beams 201 arranged parallel thereto, wherein the main transverse beam 200 is connected to an end 1310 of the support column 1300 facing away from the ground. A pivoting mechanism (not shown) is also arranged at the upper end 1310 of the support column 1300, with the aid of which the roof surface 1100 of the carport 1000 can be aligned according to the position of the sun. In the present exemplary embodiment, the support structure 2000 also has four main longitudinal beams 220, each of which is arranged parallel to one another, with a further, narrower longitudinal beam 221 positioned in each case between every two main longitudinal beams 220.

The photovoltaic panels 1200 are pressed against the support structure 2000 by means of clamping strips 230 (FIG. 1), which interact with the main longitudinal beams 220 or longitudinal beams 221. Seals 300 are arranged between the photovoltaic panels 1200 in order to obtain a liquid-tight roof surface 1100.

Furthermore, these seals 300 serve to compensate for temperature-induced mechanical stresses resulting from the different thermal coefficients of the various materials used. The material used for these seals 300 is preferably elastic and closed-cell foams made of different rubbers, for example sponge rubber or EPDM.

FIG. 3 shows a section of the roof surface 1100 of the carport 1000 of FIG. 1, wherein the support structure 2000 has a main longitudinal beam 220A with a clamping strip 230A and a longitudinal beam 221 with a further clamping strip 230, which fix the solar panel 1200A in its position. A further photovoltaic panel 1200B is arranged on the longitudinal beam 221 and a second main longitudinal beam 220B with associated clamping strips 230, 230B.

FIG. 4 shows a detailed view of the support structure 2000 of FIG. 3 without clamping strips 230, 230A, 230B and without inserted photovoltaic panels 1200A, 1200B. It can be seen here that the respective transverse beams 201 are bolted to the main longitudinal beams 220A, 220B. The longitudinal beam 221 arranged between the two main longitudinal beams 220A, 220B is in turn bolted to the transverse beams 201. The transverse beams 201 have an essentially U-shaped cross-section, while the longitudinal beam 221 and the main longitudinal beam 220 have an essentially T-shaped cross-section with a support surface 222. When assembled, the main longitudinal beam 220A arranged at the outer edge of the roof surface 1100 has a substantially vertical side surface 223A, which projects beyond the substantially horizontal support surface 222A.

In the inserted state, the photovoltaic panels 1200 rest on the support surfaces 222, 220A of the longitudinal beams 221 or main longitudinal beams 220 and are not connected to the main transverse beam 200 or the transverse beam 201 in a force-fit or form-fit manner.

FIGS. 5 to 13 show the clamping mechanism of the present invention in detail.

The clamping strip 230 has a substantially T-shaped cross-section, wherein a clamping lug 233 is formed at a proximal end 231 of the vertical web 232 of the clamping strip 230. This clamping lug 233 has three bores 234A, 234B, 234C, wherein the central bore 234B has a larger diameter than the circular bores 234A, 234C arranged to the right and left of the central bore 234B.

The longitudinal beam 220, to which the clamping strip 230 is assigned, has a slot-shaped receptacle 224 (FIG. 6), which is arranged in the support surface 222. A circular bore 225A and two elongated bores 225B, 225C oriented perpendicular to each other are provided in the side surface 223 of the longitudinal beam 220.

In the assembled state, the clamping lug 233 of the clamping strip 230 is accommodated in the slot-shaped receptacle 224 of the longitudinal beam 220, wherein a mounting position is provided in which the clamping lug 233 only partially protrudes into the slot-shaped receptacle 224.

This intermediate position allows the photovoltaic panels 1200 to be slid into the support structure 2000, with the photovoltaic panels 1200 sliding along the support surfaces 223 of the longitudinal beams 220, 220A, 220B.

The installation of the photovoltaic panels 1200 is explained in more detail below.

In a first step, the support structure 2000 of the carport 1000, consisting of the support column 1300 and the main transverse beam 200, the two transverse beams 201, the main longitudinal beams 220, 220A, 220B and the longitudinal beams 221 are bolted together.

In a next step, the clamping strips 230, 230A, 230B are arranged on the main longitudinal beams 220, 220A, 220B and the longitudinal beams 221 in such a way that in a mounting position the clamping lugs 233 of the respective clamping strips 230, 230A, 230B partially project into the slot-shaped receptacles 224 of the respective longitudinal beams 220, 220A, 220B, 221, with the clamping strips 230, 230A, 230B being fixed in this mounting position by means of a fixing means, for example by means of a mounting screw 240C (FIG. 7), which penetrates the bore 234C of the clamping lug 233 and the elongated bore 224C of the longitudinal beam 221. Here, the mounting screw 240 is arranged in an upper position in the elongated bore 224C, but is not yet tightened. This mounting position results in a gap D between the support surface 222 of the longitudinal beams 220 and the underside of the horizontal cover surface 235 of the clamping strips 230, which is greater than the overall height of the photovoltaic panels 1200 used.

For the installation of the photovoltaic panels 1200, the individual photovoltaic panels 1200 are inserted along the support surfaces 222 of the longitudinal beams 220, 221 between the clamping strips 230 and the longitudinal beams 220, 221 until they come to a stop in the region of the proximal end 231 of the clamping strips 230 (FIG. 8). The support surfaces 222 and the underside of the horizontal end 235 of the clamping strips 230 are provided with a sealing material (not shown), which prevents the ingress of moisture and is also sufficiently elastic and flexible to be able to compensate for the thermal expansion of the different materials in the assembled state.

In this embodiment of the invention, the carport 1000 has eighteen photovoltaic panels 1200, which are arranged in three rows of six photovoltaic panels 1200 each. Each photovoltaic panel 1200 has a seal 300 (FIG. 1) on those side edges which extend transversely to the direction of insertion, i.e. parallel to the transverse beams 200, 201, so that in the fully assembled state each row is sealed off from the adjacent row. This provides a watertight surface for the roof 1100 of the carport 1000.

As long as the clamping strips 230 are arranged in the mounting position, the transverse seals 300 are not yet compressed. The seals 300 are only compressed when the clamping mechanism is fixed. For this purpose, end strips 310—as shown in FIG. 9—are first fixed to the distal end 236 of the clamping strips 230 by means of a positioning tool 400.

This positioning tool 400 is shown in detail in FIG. 10. The positioning tool 100 has an essentially L-shaped leg 410, at the shorter end of which an end plate 420 is arranged in such a way that its longitudinal center plane is perpendicular to the longitudinal center plane of the L-shaped leg 410. Two positioning screws 430 are passed through this end plate 420.

As can be seen in FIG. 9, these positioning screws 430 serve to fix the end strips 310 to the edges of the photovoltaic panels 1200. The L-shaped leg 410 is arranged here essentially on the lower edge of the side surface 223 of the longitudinal beam 220A, 221. By tightening the positioning screws 430, a pretension is generated to compress the transverse seals 300 between the individual photovoltaic panels 1200. Once the desired pretension is obtained, the end strips 310 are tightened by means of fastening screws (not shown), preferably to a specified torque, and then the positioning tool 400 is removed.

In a final step, the clamping strips 230 are fixed in their end position, whereby the longitudinal seals arranged on the support surfaces 222 of the longitudinal beams 220, 221 and on the underside of the cover surface 235 of the clamping strips 230 are also compressed to be liquid-tight.

A fixing tool 500 is provided for this purpose, which can be seen in detail in FIG. 11. The fixing tool 500, which is designed as an eccentric, is inserted into the circular bore 234B of the clamping lug 233 and the central elongated bore (FIG. 12) and rotated by 150°, for example, whereby the clamping lug 233 is brought into its end position within the slot-shaped receptacle 224 of the support surface 222 of the longitudinal beam 221.

The clamping strip 230 is fixed in this clamping position with the aid of a further mounting screw 240A, which is inserted into the bore 234A facing the proximal end 236 and into the bore 225A of the longitudinal beam 221. The mounting screw 240C already located in the clamping lug 230, which served to fix the clamping strip 230 in the mounting position, is displaced from an upper position in the elongated bore 224C into the lower fixing position by lowering the clamping strip 230 into the end position and can now be tightened. As soon as the fixing of the clamping strip 230 is complete, the fixing tool 500 is removed again (FIG. 13).

In this way, the photovoltaic panels 1200 are pressed against each other, wherein seals 300 are provided on the respective side edges of the photovoltaic panels 1200 in order to obtain a liquid-tight roof surface 1100 of the carport 1000.

It is understood that the present invention is not limited to the above-mentioned embodiment. Essential to the present invention is the presence of a support structure comprising longitudinal and transverse beams, wherein the longitudinal beams interact with clamping strips when solar modules are arranged between the longitudinal beams and clamping strips. These clamping strips have clamping lugs which project into a corresponding recess in the longitudinal beams, wherein the clamping strips are in a mounting position for inserting the photovoltaic panels into the support structure and are fixed in an end position on completion of mounting, in which the photovoltaic panels are flexibly clamped between the longitudinal beams and clamping strips with the aid of seals.

1. A mounting system for solar modules, comprising:
a support structure with at least two longitudinal beams and at least one transverse beam, wherein the at least one transverse beam is arranged substantially transversely to the longitudinal beams, and wherein at least one clamping strip is associated with each longitudinal beam, wherein the at least one clamping strip has a clamping lug which can be inserted into a receptacle of a longitudinal beam, wherein the at least one clamping strip can be moved from a mounting position, in which the clamping lug (233) is only partially accommodated in the receptacle, into a clamping position in which the clamping lug is completely accommodated in the receptacle and is fixed in the clamping position.

2. The mounting system according to claim 1, wherein the at least one transverse beam has a U-profile and the at least two longitudinal beams and the clamping strips each have a T-shaped cross-section.

3. The mounting system according to claim 1, wherein at least one longitudinal seal is arranged on the at least one clamping strip and on the at least one longitudinal beam in each case.

4. The mounting system according to claim 1, wherein at least two solar modules are arranged between at least two longitudinal beams, wherein at least one transverse seal is arranged on the edges of the at least two solar modules facing one another, which transverse seal is compressed in a liquid-tight manner in the clamping position of the clamping rail.

5. The mounting system according to claim 3, wherein the at least one longitudinal seal or the at least one transverse seal are made of a closed-pore, elastic foam material.

6. The mounting system according to claim 1, wherein a positioning tool and a fixing tool are provided for moving the at least one clamping strip from the mounting position into the clamping position.

7. A method of using a mounting system according to claim 1 for producing a roof surface of a carport with solar modules or for arranging a photovoltaic system on the roof surface.

8. A method for mounting at least one solar module comprising:
mounting the at least one solar module in a support structure with at least two longitudinal beams and at least one transverse beam, wherein the at least one transverse beam is arranged substantially transversely to the longitudinal beams, and wherein at least one clamping strip is associated with each longitudinal beam, wherein the at least one clamping strip has a clamping lug which is inserted into a receptacle of a longitudinal beam, wherein the at least one clamping strip is first brought into a mounting position in which the clamping lug is only partially accommodated in the receptacle, then at least one solar module is inserted between at least two longitudinal beams and the clamping strips associated with them, and finally the clamping strips are brought into a clamping position in which the clamping lug is completely accommodated in the receptacle and is fixed in the clamping position.

9. The method according to claim 8, wherein at least two solar modules are inserted, wherein a transverse seal is arranged on the touching edges of the at least two solar modules.
